(19) United States
(12) Patent Application Publication
(10) Pub. No.: US 2022/0062078 A1
(43) Pub. Date: Mar. 3, 2022

(54) SEAT TILTING SYSTEM FOR A WHEELCHAIR

(71) Applicant: Alu Rehab AS, Klepp Stasjon (NO)

(72) Inventor: Sigve Tjessem, Figgjo (NO)

(73) Assignee: Alu Rehab AS, Klepp Stasjon (NO)

(21) Appl. No.: 17/419,980

(22) PCT Filed: Nov. 28, 2019
(86) PCT No.: PCT/NO2019/050262

§ 371 Date: Jun. 30, 2021

(30) Foreign Application Priority Data
Feb. 11, 2019 (NO) 20190189

(51) Int. Cl. A61G 5/10

(52) U.S. Cl. CPC A61G 5/1075; A61G 5/1089

(57) ABSTRACT

A wheelchair having: i) a frame, ii) a seat, iii) a backrest, iv) front wheels, v) rear wheels and vi) a handle. The frame has a wheel frame and a seat frame pivotably mounted to the wheel frame via seat frame hinges, wherein the seat mounted to the seat frame. The seat frame is coupled with the wheel frame via a joint linkage system coupled with front rods and rear rods and sets an operation angle between said front rods and said rear rods. Backward rotation of the seat causes the joint linkage system to increase the operation angle between said front rods and rear rods thereby increasing the wheel footprint of the wheelchair. Forward rotation of the seat causes the joint linkage system to decrease the operation angle between said front rods and rear rods thereby decreasing the wheel footprint of the wheelchair.

### FIELD OF THE INVENTION

The invention relates to a tiltable wheelchair comprising a frame, a seat, a backrest, front wheels, real wheels and a handle. The seat and backrest are tiltable.

### BACKGROUND OF THE INVENTION

Long-time seating may form a health risk for the human body, particularly for persons who are not able to stand up and walk around to obtain the necessary body stimulation for body health and well-being. Wheelchair users are especially prone to body problems due to long-time seating. It is known that a chair with variable seating position—for example from almost laying down to upright sitting—is of great help for avoiding sitting-related health problems.

In order to solve this problem various wheelchair manufacturers have developed tiltable wheelchairs. The tilt range of the known solutions typically ranges up to about 45 degrees backwards. When designing a tiltable wheelchair there are a couple of challenges:

A) the centre of gravity moves during tilt—until it gets outside the footprint of the wheel frame making the chair unstable—at risk of toppling. This is prevented by increasing the size of the wheelchair footprint or supplying the wheelchair with very long anti-tips and/or a large wheel frame. The result is an increased size of the wheelchair, which reduces the manoeuvrability of the wheelchair, which is important for inhouse use of a wheelchair;

B) the wheelchair wheel-frame construction often limits how far a seating unit can be tilted;

C) bringing a person up from max tilt to upright seating position can be very heavy, and

D) the driving wheels often come into conflict with the arm supports during tilting, which makes the construction/design wider than necessary.

U.S. Pat. No. 9,010,787B2 discloses a tiltable wheelchair. The wheelchair includes a base frame extending in a fore-aft direction and a lateral direction perpendicular to the fore-aft direction. The wheelchair also includes a plurality of wheels supporting the base frame for movement. The wheelchair also includes a seat frame operable to support a seat and a wheelchair occupant sitting in the seat. The wheelchair also includes a support assembly interconnecting the seat frame to the base frame for pivoting movement between an up-right position, a fully-tilted position and an intermediate position between the upright position and the fully-tilted position. The support assembly utilizes a plurality of control paths to direct the seat frame in translating and rotating planar body motion that defines a fixed centrode. A centre of gravity of the seat frame and the seat and the wheelchair occupant is definable in operation. In one aspect, the plurality of control paths are arranged such that the centre of gravity is directable during pivoting movement of the seat frame along a follower path being at least one of substantially horizontal and concave with the centre of gravity vertically lower in the intermediate position than in at least one of the upright position and the fully-tilted position. In another aspect, the seat frame is adjustably positionable relative to the base frame in the fore-aft direction such that the position of the centre of gravity is settable through adjusting along a single axis to create an alignment of the centre of gravity with the fixed centrode and thereby creates stability within the limits of the range of motion of the system.

Patent application publication GB2,437,502A discloses a wheel arrangement for a wheel-chair or pushchair comprising at least one front wheel capable of being retracted upwards and towards the rear wheels thus shortening the wheel base and tilting the seat forwards and lowering the front of the seat.

Patent application publication US2008/0054596A1 discloses a dual-mode wheelchair providing both a manoeuvrable indoor mode and a travel mode. The wheelchair comprises front wheels mounted on a front axis and rear wheels mounted on a rear axis. A distance between the front axis and the rear axis defines a wheelbase of the wheelchair. The wheelbase is alterable between a short wheelbase providing a manoeuvrable mode of the wheelchair and a long wheelbase providing a travel mode of the wheelchair. The wheelchair further provides a lowered centre of gravity and a reclining position in the travel mode to provide improved stability and occupant security.

Patent application publication GB2,544,276A discloses a height-adjustable wheelchair comprising a U-shaped frame having two long sections that form the front legs wherein the U-frame forms the back of the chair. Two further frame components form the rear legs. Each frame component is coupled and supported at one end by a sliding component. Each sliding component in turn is coupled to the front legs which facilitate the movement of rear legs radially along the length of front legs. Wheels are positioned on both front and rear legs. The frame will preferably use tubular aluminium and/or steel as the frame material. The chair may preferably use lithium batteries as a means of suppling power to the electrically driven wheels. The seated area will preferably comprise an elastic flexible material. The wheels will also preferably have a braking system attached to the front wheels.

Patent CH697181A5 discloses a wheelchair with a seating unit sitting on a carriage frame and being built as a separate unit from the frame. The seating unit comprises a seating surface, a back support and leg supports on an upright frame and can be adjusted via a first aggregate or manually adjustable upright mechanism for lifting the upright frame in a standing position or lowering it to a seating position. During tilting the centre of gravity is kept within the wheel footprint.

Patent application EP 2,823,796 A1 discloses a wheelchair with tilt capabilities. The electric wheelchair comprises a chassis, a lift device having a base member which is fixedly arranged to the chassis, and a lifting member arranged to move rectilinearly relative to the base member along an axis defined by a longitudinal extension of the lifting member, a tilt frame, a first arm pivotally coupled to the lifting member and the tilt frame, and a second arm coupled to the base member, and which second arm is pivotally coupled to the first arm forming a pivot connection. The movement of the lifting member towards the extended position moves the pivot connection towards the base member and movement of the lifting member towards the retracted position moves the pivot connection away from the base member.

In view of the above described problems and existing solutions there is a need to further develop compact tiltable wheelchairs.

### SUMMARY OF THE INVENTION

The invention has for its object to remedy or to reduce at least one of the drawbacks of the prior art, or at least provide a useful alternative to prior art.

The object is achieved through features, which are specified in the description below and in the claims that follow.

The invention is defined by the independent patent claims. The dependent claims define advantageous embodiments of the invention.

In a first aspect the invention relates to a wheelchair comprising: i) a frame, ii) a seat, iii) a backrest, iv) front wheels, v) rear wheels and vi) a handle. The frame comprises a wheel frame and a seat frame pivotably mounted to the wheel frame via seat frame hinges, wherein the seat is mounted to the seat frame. Both sides of the wheel frame comprise a front rod and rear rod being pivotably mounted to the horizontal wheel frame via said wheel frame hinges. Said front wheels are (directly or indirectly) mounted to the end of the front rods (in some embodiments these front wheels are mounted to a lower frame that is mounted to the front rods) and said rear wheels are mounted to said rear rods. The seat frame is coupled with the wheel frame via said seat frame hinges (which also pivotable connect the front and rear rods) and a joint linkage system, the joint linkage system setting an operation angle between said front rods and said rear rods. The seat frame, wheel frame and the joint linkage system are configured such that backward rotation of the seat causes the joint linkage system to increase the operation angle between said front rods and rear rods thereby increasing a distance between respective far ends of the front rods and the rear rods and thereby increasing the wheel footprint of the wheelchair. Furthermore, the seat frame, wheel frame and the joint linkage system are configured such that forward rotation of the seat causes the joint linkage system to decrease the operation angle between said front rods and rear rods thereby decreasing the distance between respective far ends of the front rods and the rear rods and thereby decreasing the wheel footprint of the wheelchair.

The effects of the features of the wheelchair in accordance with the invention are as follows. First of all, the core of the mechanical construction of the frame of the wheelchair is the wheel frame comprising the front rod and rear rod, which are pivotably mounted via wheel frame hinges, which means that the front rod and read rod can pivot relative to each other. Second, the seat frame is pivotably mounted to the wheel frame via seat frame hinges. An interesting aspect of the invention is that in some embodiments the seat frame hinges coincide with the wheel frame hinges, which means that their axes coincide. This feature is not essential to the invention, but rather advantageous as it saves pivot points in the system, but also improves the stability of the wheelchair during pivoting. A third key feature is the joint linkage system that couples the seat frame with the wheel frame and rear rods of the wheel frame and sets the operation angle between said front rods and rear rods. Finally, the seat frame, wheel frame and the joint linkage system are configured such that backward rotation of the seat causes the joint linkage system to increase the operation angle between said rods for increasing the distance between far ends thereof. As the rear wheels are mounted to the rear rods this also results in an increase of the wheel footprint of the wheelchair. Also, forward rotation of the seat causes the joint linkage system to decrease the operation angle between said rods for decreasing the distance between far ends thereof and thereby decreasing the wheel footprint. The total effect of these features is that a very convenient and effective tilting system is obtained, which ensures that the centre point of gravity of the wheelchair remains within the wheel footprint. It goes without saying that when the seat and backrest are titled backward with a user sitting in the wheelchair, the centre point of gravity of the user of the wheelchair moves in the direction of the rear wheels. It goes without saying that when the rear wheels move in the same direction (which is what effectively happens when the wheel foot print increases in the invention and will be further explained with reference to the figures) the centre point of gravity will stay within the wheel foot print.

In order to facilitate understanding of the invention one or more expressions are further defined hereinafter.

Wherever the word “hinge” is used, this must be interpreted as equivalent to “pivot point” or “rotation axle” or any other means to pivotably connect two or more mechanical parts.

Wherever the word “rod” is used, this must be interpreted as equivalent to “bar”, “arm”, “tubular structure”, or any other mechanical elongate structure that may form part of a frame.

Wherever the word “wheel footprint” is used, this must be interpreted as the heart-heart distance between the front and rear wheels.

In an embodiment of the wheelchair in accordance with the invention the joint linkage system comprises one joint linkage on each opposing side of the wheelchair. The joint linkage comprises three hinged staffs mounted in a star configuration having a central common hinge which pivotably connects said hinged staffs together. A first one of said hinged staffs is pivotably coupled with the seat frame at a location between the seat frame hinge and the backrest. A second one of said hinged staffs is pivotably coupled with the wheel frame close to an end of a respective one of said front rods. A third one of said hinged staffs is pivotably coupled with and end of a respective one of said back rods. This embodiment functions as follows. Backward tilt of the seat causes the first one of the hinged staffs to press the central common hinge to move in a downward direction and thereby making the second hinged staff and third hinged staff press backward for increasing the distance between respective far ends of the front rod and the rear rod and thereby increasing the wheel footprint of the wheelchair. This will be further explained with reference to the figures.

In an embodiment of the wheelchair in accordance with the invention the wheel frame comprises a lower frame that is mounted to far ends of said rods via respective connections. One of said connections is fixed while the other one of said connections comprises a sliding mechanism, wherein said respective rod is able to slide over said lower frame over a predefined length allowing the wheel footprint of the wheelchair to be modified. The provision of the lower frame that is mounted to far ends of said rods results in a much more rigid construction. Obviously, as the distance between said far ends must be able to be varied, one of said connections must be slideable. What is important for both connections is that they allow for rotation relative to the far ends of said rods. So, there should be at least a pivot point in each connection. This will be elaborated upon with reference to the figures.

In an embodiment of the wheelchair in accordance with the invention the connection between the lower frame and the front rods is fixed, while the connection between the lower frame and the rear rods comprises the sliding mechanism. This construction allows for the rear wheels to move backward the most during pivoting of the rear rod. For illustration purposes, if the connection to the rear rod would be fixed, then the front wheels would move to the front during increase of the wheel footprint. The invention still works in that embodiment, because during pivoting of the rear rod the centre point of gravity (together with the hinge of the seat frame) of the chair will move to the front. Explained differently, even in that embodiment the rear wheels will move backward relative to the centre point of gravity. This implies that the position of the actuator must be adapted to the different construction, for example from the back side of the seat frame to the back side of the wheel frame. This will be explained with reference to the figures.

In an embodiment of the wheelchair in accordance with the invention the seat is suspended by the seat frame via a seat frame support, wherein the seat frame hinges couple said seat frame support to the wheel frame. Furthermore, the seat frame, the seat frame support and the seat frame hinges are configured such that, in operational use, the seat frame is located at a level below the position of said seat frame hinges. The advantage of this embodiment is that a backward tilt of the seat and backrest result in the centre point of gravity of the seat moving to the front, thus adding to the effect of the rear wheels moving to the back during increase of the footprint.

In an embodiment of the wheelchair in accordance with the invention the wheelchair further comprises an actuator (mechanical spring or gas spring) mounted between the seat frame and the wheel frame for controlling and limiting said rotation of the seat. The actuator controls the speed and stop the movements of the rods and the joint linkage system, which may help to tilt the seat to the front or the back, even when a person is sitting in the chair. The actuator is selected from the group consisting of: a mechanical spring, a (lockable) gas spring, and an electrical actuator.

In an embodiment of the wheelchair in accordance with the invention the wheelchair further comprises an anti-tipping device mounted at the rear side for preventing tip over of the wheelchair. Anti-tipping devices are well-known in the art, but in this embodiment the anti-tipping device is conveniently mounted at the rear end of the rear rod which moves backward (at least relatively) when the seat is tilted backwards.

In a second aspect the invention relates to a chair, for instance a resting or relax chair, comprising: a frame, a seat and a backrest, wherein the frame comprises a support frame and a seat frame pivotably mounted to the support frame via seat frame hinges, wherein the seat is mounted to the seat frame. Both sides of the support frame comprise a front rod and rear rod being pivotably mounted to said front rod via said seat frame hinge. The seat frame is coupled with the support frame via a joint linkage system coupled with said front rods and rear rods, the tilt joint linkage setting an operation angle between said front rods and said rear rods. The seat frame, support frame and the tilt joint linkage system are configured such that backward rotation of the seat causes the joint linkage system to increase the operation angle between said front rods and rear rods thereby increasing a distance between respective far ends of the front rods and the rear rods and thereby increasing the footprint of the chair, and such that forward rotation of the seat causes the joint linkage system to decrease the operation angle between said front rods and rear rods thereby decreasing the distance between respective far ends of the front rods and the rear rods and thereby decreasing the footprint of the chair. After the wheelchair was invented, the inventor realized that the construction used in the wheelchair of the invention is also valuable for comfortable resting chairs. Example of such resting and relax chairs are: TV chairs, with or without wheels, or with small wheels just for moving the comfort chair a little in the living room. In any case in the wheelchair of the invention the wheels may be replaced with static feet and the invention will still work exactly the same way. Since the tilting mechanism mainly resides in the sides of the chair it opens up possibilities for other chair designs. The controlling actuator in some embodiments may be moved to the sides leaving free space underneath. Combining back recline and tilt would allow for a comfort chair with substantially more tilting movement than ordinary comfort resting chairs.

### BRIEF INTRODUCTION OF THE DRAWINGS

In the following is described examples of preferred embodiments illustrated in the accompanying drawings, wherein:

FIG. 1 shows a perspective view of an embodiment of a wheelchair in accordance with the invention with the seat in its normal position;

FIG. 2 shows a perspective view of the wheelchair of FIG. 1 with the seat tilted backward;

FIGS. 3a-3c show side views of the wheelchair of FIG. 1, with the seat and backrest in different tilt positions;

FIG. 4 shows a perspective view of part of the frame of the wheelchair of FIG. 1, when the seat is tilted slightly forward;

FIG. 5 shows a perspective view of part of the frame of FIG. 4, when the seat is tilted fully backward;

FIG. 6 shows a side view of the frame of FIG. 4;

FIG. 7 shows a side view of the frame of FIG. 6 with the seat put in its horizontal position, and

FIG. 8 shows a side view of the frame of FIG. 5 with the seat put in its backward tilted position.

### DETAILED DESCRIPTION OF THE EMBODIMENTS

Various illustrative embodiments of the present subject matter are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various systems, structures and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In the development of the wheelchair of the invention the following purpose was kept in mind. The purpose of the invention is to provide a wheelchair frame wherein:

a) backward tilting of the seating unit is possible up to 45 degrees from the horizontal position;

b) the wheelchair stability is maintained even when the seating unit is tilted 45 degrees;

c) the arm-supports do not conflict with the driving wheels when tilted backward;

d) the wheelchair does not require more space than an ordinary wheelchair when using the wheelchair in upright seating position;

e) the main wheels are ergonomically correctly placed for self-propelling in upright position, and

f) it is easy and well-controlled/safe to tilt the seating unit with a person in it and easy and light to bring the person up to an upright seating position again.

The invention will be discussed with reference to the figures hereinafter.

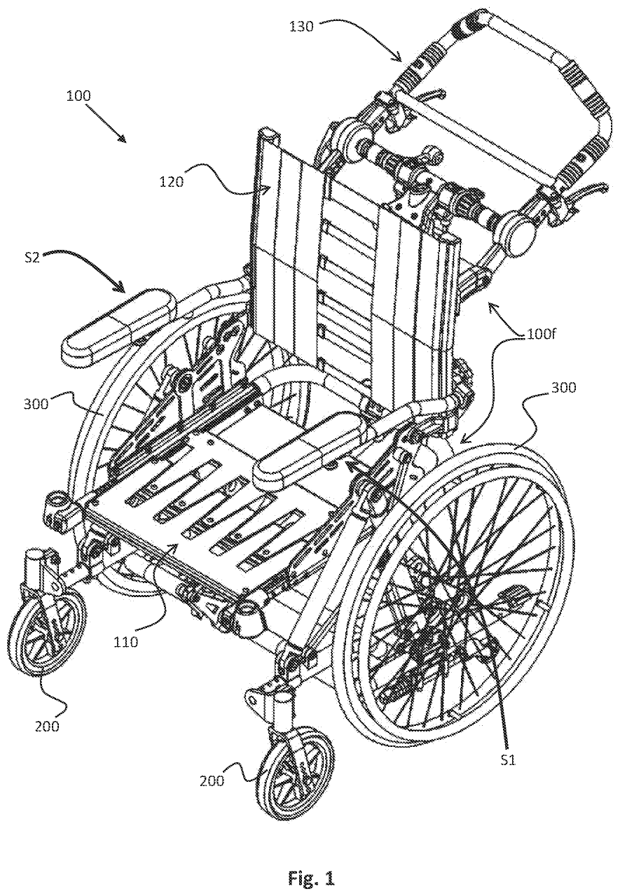

FIG. 1 shows a perspective view of an embodiment of a wheelchair 100 in accordance with the invention with the seat in its normal position. The wheelchair 100 comprises a seat 110, a backrest 120 mounted to the seat, and a handle 130 mounted to the wheelchair 100. The handle 130 comprises some control levers and is connected to a frame 100f, which will be discussed in more detail with reference to other figures. The wheelchair 100 further comprises a pair of front wheels 200, which are rotationally mounted to a front side of the frame 100f of the wheelchair 100. The wheelchair 100 further comprises a pair of rear wheels 300 (drive wheels) mounted to the backside of the frame 100f of the wheel-chair 100. The figure further illustrates that the wheelchair 100 has a left side S1 and a right side S2. This definition of the sides of the wheelchair 100 is important in view of the claims, where the word “side” is used at various places. In fact, the wheelchair 100 in accordance with the invention comprises a construction having components and parts which reside at the sides S1, S2, i.e. each side S1, S2 comprises pivoting, moving and translating parts as will be explained with reference to the other figures.

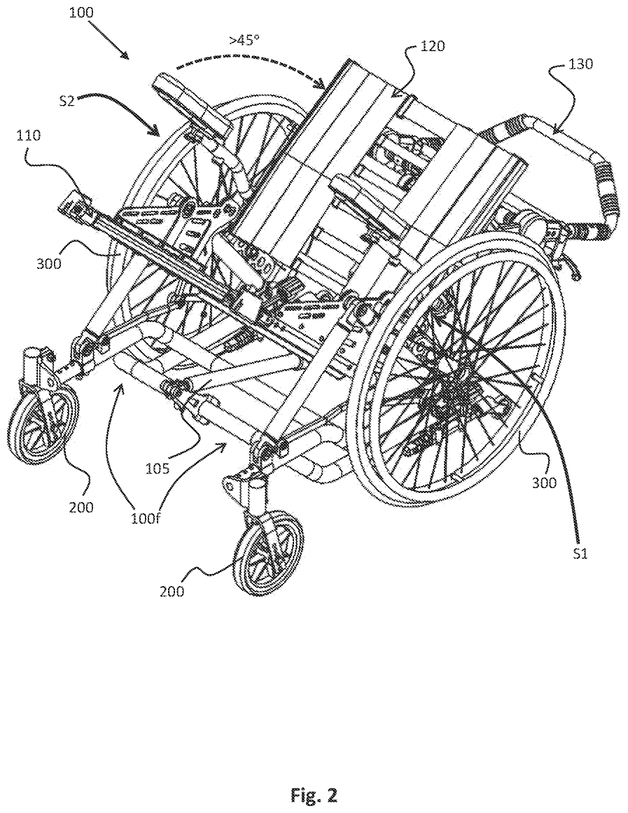

FIG. 2 shows a perspective view of the wheelchair 100 of FIG. 1 with the seat 110 tilted backward. The seat 110 has been tilted 45 degrees backward. As the seat 110 in FIG. 1 is actually tilted 5 degrees towards the front side the total tilt angle is over 45 degrees, i.e. 50 degrees. The seat 110 and the backrest 120 are fixedly mounted together, i.e. they always tilt together. In other places of the description it is often referred to tilting of the seat 110. It must be borne in mind that the backrest also tilts, but that this is not always mentioned. In the position of the wheelchair 100 in FIG. 2 there is also visible an actuator 105 coupled between pivoting parts of the frame 100f, which controls, limits and supports the tilting of the seat 110 as will be explained with reference to other figures. The actuator 105 may be selected from a group comprising: a mechanical spring, a (lockable) gas spring or an electrical actuator.

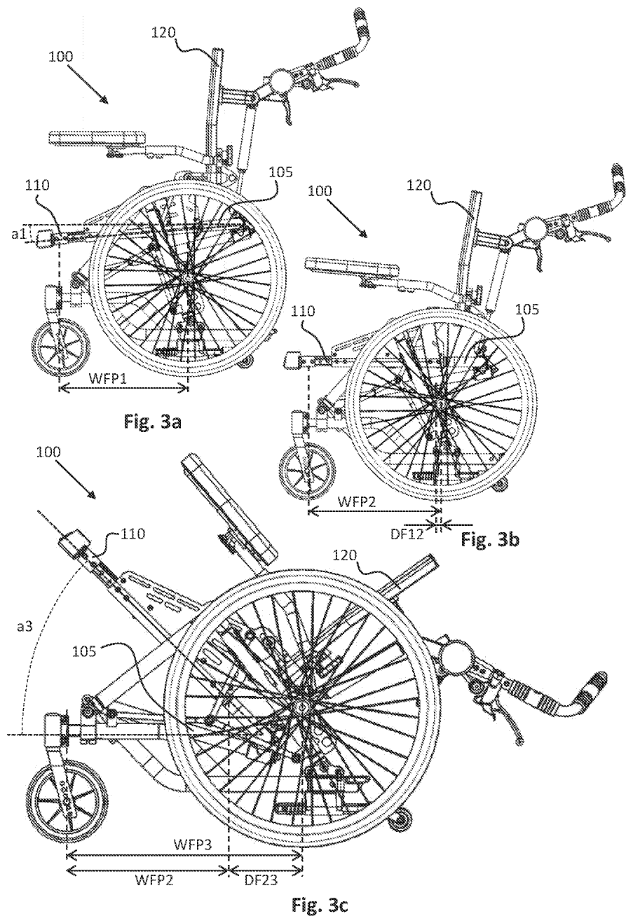

FIGS. 3a-3c show side views of the wheelchair 100 of FIG. 1, with the seat 110 and backrest 120 in different tilt positions. In FIG. 3a the seat 110 is tilted 5 degrees forward relative to the horizontal plane, i.e. angle a1 is 5 degrees. In FIG. 3b the seat 110 is oriented horizontally. In FIG. 3c the seat 110 is tilted backward by 45 degrees relative to the horizontal plane, i.e. angle a3 is 45 degrees. These figures serve to illustrate an important aspect of the invention concerning the variation of the wheel footprint of the wheelchair 100. In FIG. 3a the wheel footprint WFP1 is smallest.

When the seat 110 is tilted backward with 5 degrees, the wheel footprint WFP2 has become larger, which is also illustrated by the small arrow DF12, which represents the wheel footprint increase from the first (FIG. 3a) to the second seat position (FIG. 3b). When the seat 110 is further tilted backward with 45 degrees, the wheel footprint WFP3 has become largest, which is also illustrated by the larger arrow DF23, which represents the wheel footprint increase from the second (FIG. 3b) to the third seat position (FIG. 3c).

FIGS. 3a-3c also serve to illustrate that the rear wheels move backward during backward tilting of the seat 110. This backward movement is at least relative to the pivot point of the wheelchair (and thereby also the centre point of gravity). This increases the stability of the wheelchair 100 significantly during tilting.

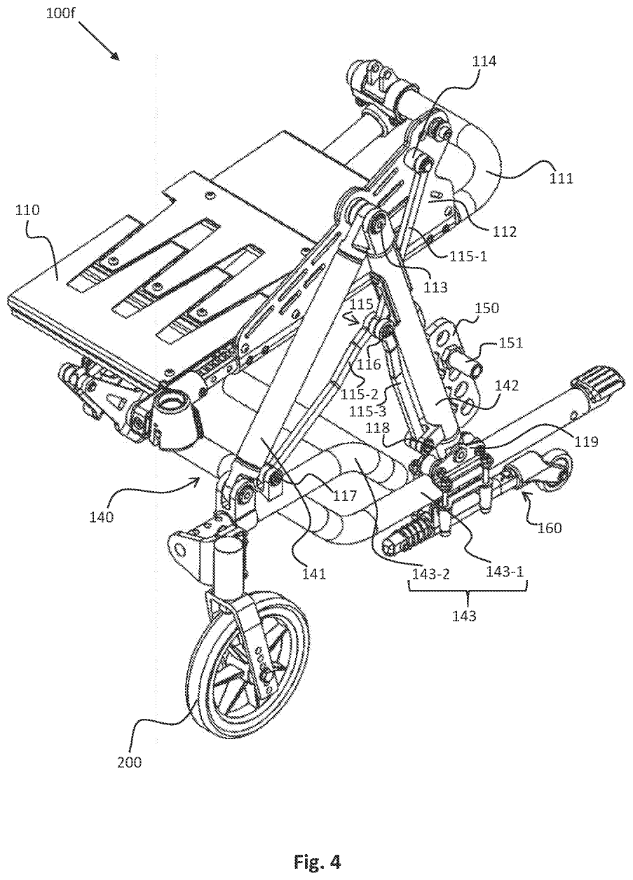

FIG. 4 shows a perspective view of part of the frame 100f of the wheelchair 100 of FIG. 1, when the seat 110 is tilted slightly forward (with 5 degrees). In the figure the wheelchair 100 is cut in half, the backrest and handle are removed, and the rear wheels have been taken off, all for illustration purposes. The seat 110 is mounted in a seat frame 111 as illustrated. The seat frame 111 is suspended between seat frame supports 112 (only one is shown obviously), which are pivotably mounted to seat frame hinges 113 as illustrated. The seat 110, seat frame 111 and the seat frame supports 112 are pivotably suspended between a wheel frame 140 through said seat frame hinges 113. The wheel frame 140 is built up out of front rods 141 and rear rods 142 that are pivotably mounted through wheel frame hinges 113, which in this embodiment coincides with the seat frame hinges 113 (this is advantageous, but not essential). These rods 141, 142 of the wheel frame 140 are pivotably connected to a lower frame 143, which comprises a horizontal rear frame bar 143-1 and a front frame bar 143-2 as illustrated. During pivoting of the rods 141, 142 the rear rod 142 may slide along the horizontal rear frame bar 143-1 through a sliding mechanism 119 as illustrated. A rear wheel support frame 150 having a plurality of holes and a rear wheel axle 151 is mounted to each rear rod 142 as illustrated. In this way differently sized rear wheels (not shown) may be mounted on different positions to set the wheelchair 100 on different heights. Anti-tipping devices 160 are mounted to the rear rod 142 as illustrated such that it may slide together with the sliding mechanism 119. Each side of the frame 100f of the wheelchair 100 further comprises a tilt joint linkage 115, which comprises a plurality of hinged staffs (may also be called hinged bars or hinged rods) 115-1, 115-2, 115-3 that are pivotably mounted to a central common hinge 116 forming a star configuration as referred to in the claims. Each tilt joint linkage 115 is pivotably connected to respective part of the frame 100f. A first one of the hinged staffs 115-1 is pivotably mounted to the seat frame support 112 through a seat hinge 114 as illustrated. A second one of the hinged staffs 115-2 is pivotably mounted to the lower frame 143 through a reference hinge 117 as illustrated. A third one of the hinged staffs 115-3 is pivotably mounted to the rear rod 142 through an actuating hinge 118 as illustrated. Other aspects of the frame 100f and the functioning of the wheelchair 100 will be discussed with reference to other figures.

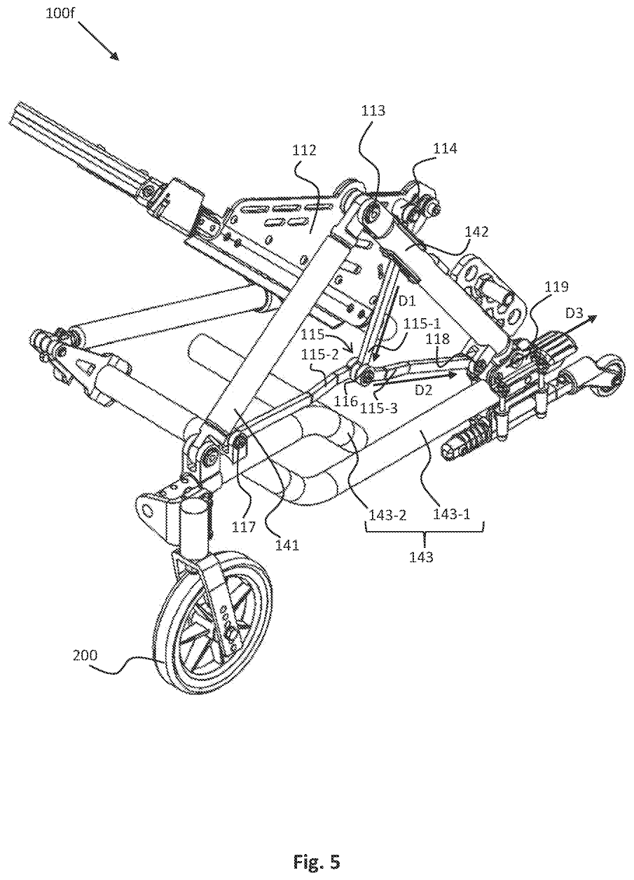

FIG. 5 shows a perspective view of part of the frame 100f of FIG. 4, when the seat 110 is tilted fully backward. This figure serves to illustrate what happens with the joint linkage 115 when the seat 110 is tilted backward. The first hinged staff 115-1 moves in the downward direction D1 as illustrated. During this movement forces are transferred to the second hinged staff 115-2 via the central hinge 116, but as the reference hinge 117 is fixed to the lower frame 143 the central hinge 116 of the joint linkage 115 is moved in the horizontal direction D2 as illustrated. This movement is in its turn transferred to the rear rod 142 via actuating hinge 118. As a result of this movement, the sliding mechanism 119 moves in the direction D3 parallel to the horizontal rear frame bar 143-1 as illustrated.

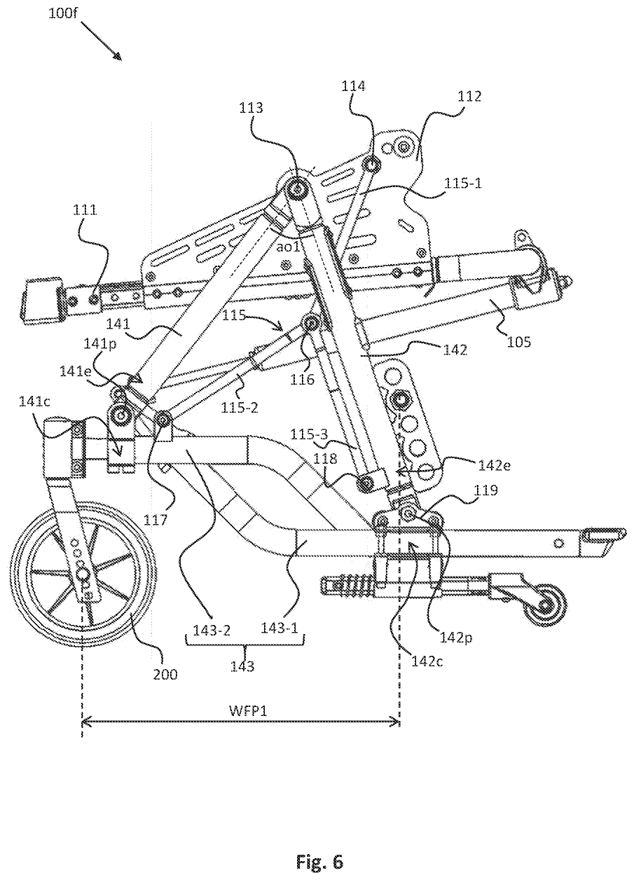

FIGS. 6 to 8 serve to illustrate further aspects of the invention that have not yet been discussed in view of FIGS. 1 to 5. All the aspect discussed in view of FIGS. 1 to 5 also apply to FIGS. 6 to 8.

FIG. 6 shows a side view of the frame of FIG. 4. This figure serves to illustrate the operation angle ao1 between the front rods 141 and the rear rods 142 when the seat is tilted forward (5 degrees relative to horizontal).

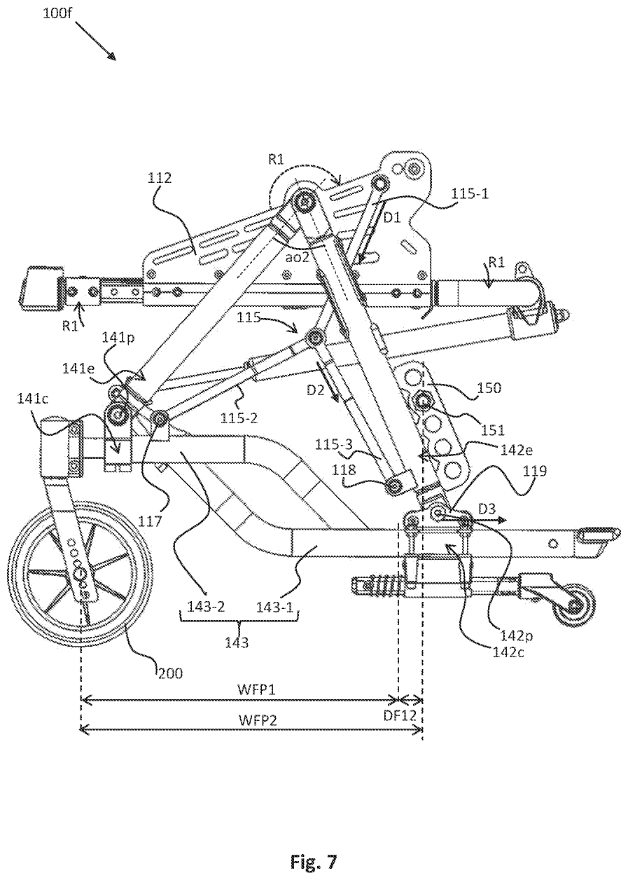

FIG. 7 shows a side view of the frame of FIG. 6 with the seat put in its horizontal position. This figure serves to illustrate the operation angle ao2 between the front rods 141 and the rear rods 142 when the seat is oriented horizontally. It is visible that the operation angle ao2 is slightly larger than in FIG. 6. The figure also illustrates the backward rotation direction R1 (with the curved arrows) as discussed in the claims.

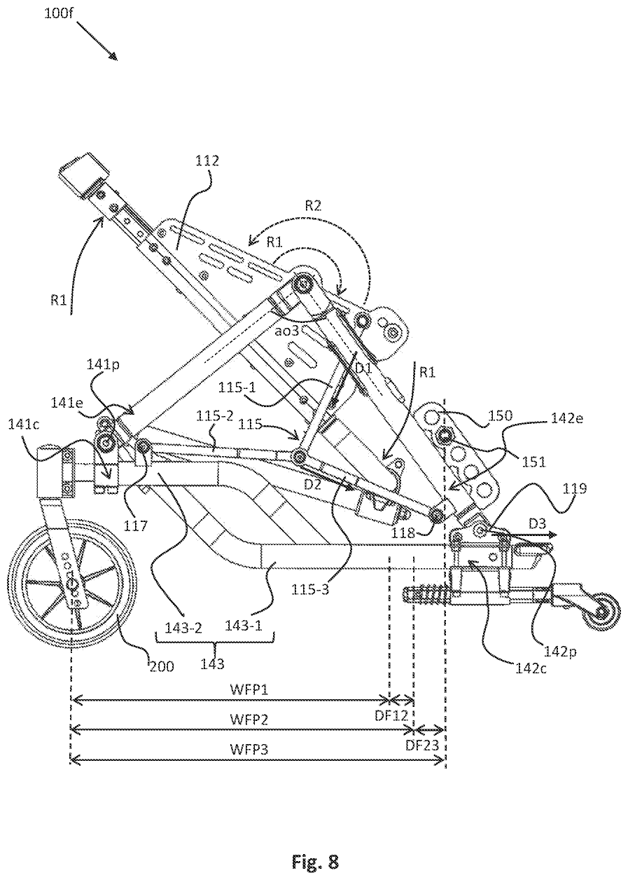

FIG. 8 shows a side view of the frame of FIG. 5 with the seat put in its backward tilted position (45 degrees relative to horizontal). It is visible that the operation angle a03 is significantly larger than in FIG. 6. This figures also illustrates both the backward rotation direction R1 and the forward rotation direction R2 (with the curved arrows) as discussed in the claims.

FIGS. 6 to 8 also illustrate the connections between the front rods 141 and rear rods 142. The front rod 141 has a far end 141e (as illustrated) which forms a pivotable connection 141c with front frame bar 143-2 of the lower frame 143 through a pivot point 141p. The rear rod 142 has a far end 142e (as illustrated) which forms a pivotable connection 142c with rear frame bar 143-1 of the lower frame 143 through a pivot point 142p. In addition the rear connection 142c is also slideable along the rear frame bar 143-1 through sliding mechanism 119 as earlier discussed. Expressed differently, in the current embodiment the choice was made to make the rear connection 142c slideable and the front connection 141c fixed. However, in an alternative embodiment this may be reversed, i.e. that the front connection 141c is slideable and the rear connection 142c is fixed. Obviously, this requires a different design of the lower frame, but it is feasible and will effectively work the same way as the other embodiment. As long as the seat is pivotably connected to the front rod and/or rear rod as illustrated the footprint of the wheelchair will increase as the operation angle ao1 . . . ao3 becomes larger. In addition, even when the rear connection 142c is fixed the rear wheels 300 will still move backward during tilting of the wheelchair, considered relative to the pivot point of the seat 110. Also, as earlier discussed, the fact that the seat 110 is suspended between a seat frame support 112 effectively will make the seat move forward when tilted backward, which adds to the stability.

As has been illustrated and discussed with reference to the figures the patent concerns a wheelchair having embodiments:
A) with a lower frame and a seating unit frame that are connected with a hinge construction on each side, allowing of 45 degrees tilt of the seating frame and leaving the space under the seat frame open for the seat unit to tilt.
B) with the hinged construction allowing the connection point between seating frame and the lower fame (the main wheels) to move backwards, which increases the size of the wheel footprint and ensures stability when the seating unit is tilted.
C) that connect the seat frame and the lower frame with a gas spring or similar to control and limit the movements of the seat and also the main wheels (alternatively this may be a mechanical spring, lockable gas spring, or an electrical actuator).
D) the hinge construction connects the lower frame with the seat frame with two hinged rods and three hinged staffs on each side of the wheelchair, as explained.
E) the front rod is hinged to the lower frame and the seating frame thereby connecting them. The rear rod is hinged at the same axle as the front rod on the seating frame, with wheels rolling on the lower frame on the other end.
F) the three hinged staffs are hinged together in one central point. The front staff is in the other end hinged to the lower frame. The upper staff is hinged to the seat frame. The lower back staff is hinged to the rear rod.
G) the rear wheel (drive wheel) is fixed to the rear rod. The drive wheel thereby follow the rear rod position.
H) the anti-tipping device is connected to the rear rod, following the rear rod and keeping the same correct position to the rear wheel at all times when the rod is moving.

The wheelchair in accordance with the invention has a newly-invented hinged-frame, which makes it possible to change the seating position from an upright active seating position—where the wheelchair user can drive the wheelchair him/herself by self-propelling like any standard manual wheelchair—to a tilted position by adjusting the seating unit angle backwards to a maximum of 45 degrees. Varying the seat unit tilt changes the weight distribution of the body to the cushions relieving pressure points and helps to prevent seating ulcers. It gives the user a variety of positions and makes it more comfortable to spend hours in a chair.

When operating the tilt cylinder the seat tilts backwards while the main wheels move backwards relative to the seat. When operating the tilt cylinder and lifting slightly, the seating unit returns to upright position and the main wheels moves closer to the front wheels reducing the footprint/space required for the chair.

In the introductory part of the description it was already mentioned that the pivoting construction of the frame of the wheelchair may be used in different chairs than wheelchairs, such as relax chairs, comfort chairs, TV chairs, etc. Such chairs may have wheels or they may not. In any case the pivoting construction still works, even without rear wheels. In the case that both the rear wheels and the front wheels are exchanged with fixed feet it may be beneficial that the back feet are mounted on a non-moving part of the under frame, such as the end of the horizontal rear frame bar 143-1 in FIGS. 6 to 8. In that case the pivoting of the chair will not result in the feet sliding over the floor because of an increasing footprint.

The particular embodiments disclosed above are illustrative only, as the invention may be modified and practiced in different but equivalent manners apparent to those skilled in the art having the benefit of the teachings herein. For example, variations are possible in the way parts are connected or coupled. The person skilled in the art may easily find alternative solutions for tightening, tensioning and mounting parts. The invention covers all these variants as long as they are covered by the independent claims. No limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

It should be noted that the above-mentioned embodiments illustrate rather than limit the invention, and that those skilled in the art will be able to design many alternative embodiments without departing from the scope of the appended claims. In a claim, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage. In the device claims enumerating several means, several of these means may be embodied by one and the same item of hardware.

1. A wheelchair comprising:
a frame, a seat, a backrest, front wheels, rear wheels and a handle, wherein the frame comprises a wheel frame and a seat frame pivotably mounted to the wheel frame via seat frame hinges, wherein the seat is mounted to the seat frame,
wherein both sides of the wheel frame comprise a front rod and rear rod being pivotably mounted to said front rod via said seat frame hinge, wherein said front wheels are mounted to the front rods and said rear wheels are mounted to said rear rods,
wherein the seat frame is coupled with the wheel frame via a joint linkage system coupled with said front rods and rear rods, the joint linkage system setting an operation angle between said front rods and said rear rods, and
wherein the seat frame, wheel frame and the joint linkage system are configured such that backward rotation of the seat causes the joint linkage system to increase the operation angle between said front rods and rear rods thereby increasing a distance between respective far ends of the front rods and the rear rods and thereby increasing the wheel footprint of the wheelchair, and such that forward rotation of the seat causes the joint linkage system to decrease the operation angle between said front rods and rear rods thereby decreasing the distance between respective far ends of the front rods and the rear rods and thereby decreasing the wheel footprint of the wheelchair.

2. The wheelchair according to claim 1, wherein the joint linkage system comprises one joint linkage on each opposing side of the wheelchair, wherein the joint linkage comprises three hinged staffs mounted in a star configuration having a central common hinge which pivotable connects said hinged staffs together, wherein a first one of said hinged staffs is pivotably coupled with the seat frame at a location between the seat frame hinge and the backrest, wherein a second one of said hinged staffs is pivotably coupled with the wheel frame close to the end of a respective one of said front rods, and wherein a third one of said hinged staffs is pivotably coupled with an end of a respective one of said back rods.

3. The wheelchair according to claim 2, wherein the wheel frame comprises a lower frame that is mounted to far ends of said rods via respective connections, wherein one of said connections is fixed while the other one of said connections comprises a sliding mechanism, wherein said respective rod is able to slide over said lower frame over a predefined length allowing the wheel footprint of the wheelchair to be modified.

4. The wheelchair according to claim 3, wherein the connection between the lower frame and the front rods is fixed, while the connection between the lower frame and the rear rods comprises the sliding mechanism.

5. The wheelchair according to claim 1, wherein the seat is suspended to the seat frame via a seat frame support, wherein the seat frame hinges couple said seat frame support to the wheel frame, wherein the seat frame, the seat frame support and the seat frame hinges are configured such that, in operational use, the seat frame is located at a level below the position of said seat frame hinges.

6. The wheelchair according to claim 1, the wheelchair further comprising an actuator mounted between the seat frame and the wheel frame for controlling and limiting said rotation of the seat.

7. The wheelchair according to claim 6, wherein the actuator is selected from the group consisting of: a mechanical spring, a (lockable) gas spring, and an electrical actuator.

8. The wheelchair according to claim 1, the wheelchair further comprising an antitipping device mounted at the rear side for preventing tip over of the wheelchair.

9. A chair comprising:
a frame, a seat and a backrest, where-in the frame comprises a support frame and a seat frame pivotably mounted to the support frame via seat frame hinges, wherein the seat is mounted to the seat frame,
wherein both sides of the support frame comprise a front rod and rear rod being pivotably mounted to said front rod via said seat frame hinge,
wherein the seat frame is coupled with the support frame via a joint linkage system coupled with said front rods and rear rods, the joint linkage setting an operation angle between said front rods and said rear rods, and
wherein the seat frame, support frame and the joint linkage system are configured such that backward rotation of the seat causes the joint linkage system to increase the operation angle between said front rods and rear rods thereby increasing a distance between respective far ends of the front rods and the rear rods and thereby increasing the footprint of the chair, and such that forward rotation of the seat causes the joint linkage system to decrease the operation angle between said front rods and rear rods thereby decreasing the distance between respective far ends of the front rods and the rear rods and thereby decreasing the footprint of the chair.
